(19) United States
(12) Patent Application Publication
(10) Pub. No.: US 2016/0202838 A1
(43) Pub. Date: Jul. 14, 2016

(54) NOISE ELIMINATING METHOD AND ADAPTER

(71) Applicant: AU OPTRONICS CORP., Hsin-Chu (TW)

(72) Inventor: Min Pao Lin, Hsin-Chu (TW)

(21) Appl. No.: 14/978,549

(22) Filed: Dec. 22, 2015

(30) Foreign Application Priority Data
Jan. 12, 2015 (TW) 104100990

(51) Int. Cl. G06F 3/041

(52) U.S. Cl. CPC G06F 3/0418

(57) ABSTRACT

A noise eliminating method adapted to be used with an adapter and a touch device electrically connected with each other is provided. The adapter includes a voltage transformer, a switch and a control circuit. The voltage transformer includes a primary side winding and a secondary side winding. The switch is electrically connected between the primary side winding and a reference voltage. The control circuit is configured to output a pulse width modulation signal to switch on or off the switch. The touch device includes a touch control circuit. The noise eliminating method includes: configuring the control circuit to receive a control signal transmitted from the touch control circuit; and configuring the control circuit to adjust at least one of a frequency, a duty cycle, a rising time or a falling time of the pulse width modulation signal according to the control signal.

### TECHNICAL FIELD

The present disclosure relates to a noise eliminating method, and more particularly to a noise eliminating method used between an adapter and a touch device electrically connected with each other.

### BACKGROUND

Currently, a general touch device is provided with a flyback-type adapter. The flyback-type adapter is used to convert an alternating current voltage to a direct alternating voltage for driving the touch device. However, when the internal switch in the flyback-type adapter has a high-frequency switch on or switch off, a high-frequency harmonic signal may be generated. Consequentially, the touch device may have abnormal functions if the high-frequency harmonic signal and the signal for driving the touch device have overlapping frequencies. In other words, the high-frequency noise signal generated by a flyback-type adapter may negatively affect the normal operation of a touch device electrically connected to the flyback-type adapter.

### SUMMARY

The present disclosure provides a noise eliminating method adapted to be used with an adapter and a touch device electrically connected with each other. The adapter includes a voltage transformer, a switch and a control circuit. The voltage transformer includes a primary side winding and a secondary side winding. The switch is electrically connected between the primary side winding and a reference voltage.

The control circuit is configured to output a pulse width modulation signal to switch on or off the switch. The touch device includes a touch control circuit. The noise eliminating method includes: configuring the control circuit to receive a control signal transmitted from the touch control circuit; and configuring the control circuit to adjust at least one of a frequency, a duty cycle, a rising time or a falling time of the pulse width modulation signal according to the control signal.

The present disclosure further provides an adapter, which includes voltage transformer, a switch and a control circuit. The voltage transformer includes a primary side winding and a secondary side winding. The switch is electrically connected between the primary side winding and a reference voltage. The control circuit is configured to output a pulse width modulation signal to switch on or off the switch. The control circuit is further configured to adjust at least one of a frequency, a duty cycle, a rising time or a falling time of the pulse width modulation signal according to a control signal.

### BRIEF DESCRIPTION OF THE DRAWINGS

The present disclosure will become more readily apparent to those ordinarily skilled in the art after reviewing the following detailed description and accompanying drawings, in which:

FIG. 1 is a schematic diagram of an adapter used with a touch device in accordance with an embodiment of the present disclosure;

FIG. 2 is a flow char of a noise eliminating method in accordance with an embodiment of the present disclosure; and

FIG. 3 is a schematic circuit diagram of a flyback-type adapter in accordance with an embodiment of the present disclosure.

### DETAILED DESCRIPTION OF PREFERRED EMBODIMENTS

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

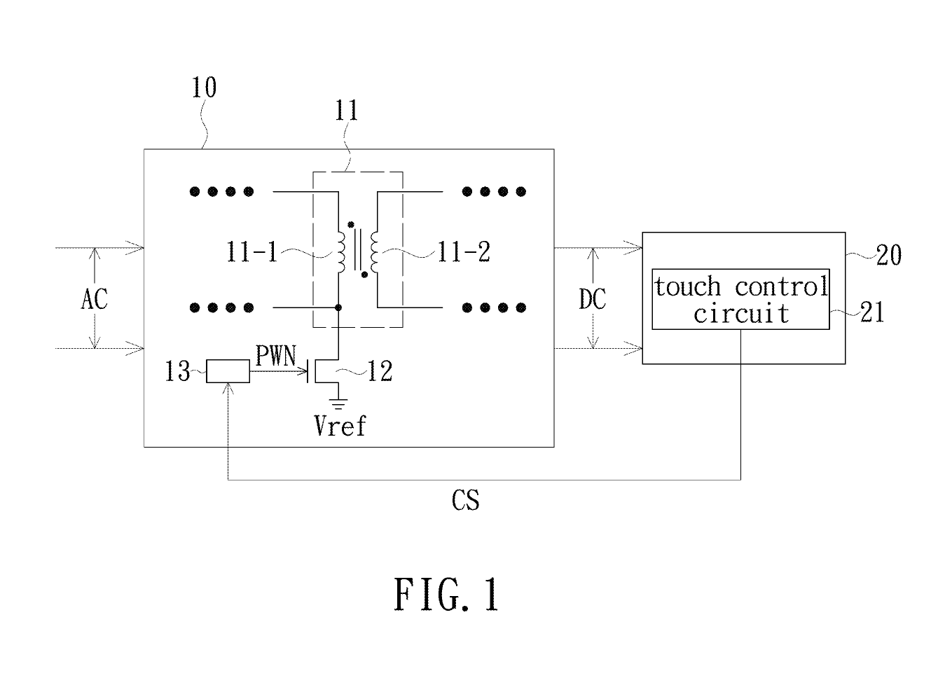

FIG. 1 is a schematic diagram of an adapter used with a touch device in accordance with an embodiment of the present disclosure. As shown in FIG. 1, the adapter 10 in the present embodiment includes a voltage transformer 11, a switch 12 and a control circuit 13. The voltage transformer 11 includes a primary side winding 11-1 and a secondary side winding 11-2. The switch 12 is electrically connected between the primary side winding 11-1 and a reference voltage Vref. In one embodiment, the reference voltage Vref is grounded. The control circuit 13 is configured to output a pulse width modulation signal PWM to switch on or off the switch 12. The adapter 10 is electrically connected to the touch device 20. The touch device 20 includes a touch control circuit 21. The touch control circuit 21 is configured to transmit a control signal CS to the control circuit 13, so that the control circuit 13 can adjust at least one of the frequency, duty cycle, rising time or falling time of the pulse width modulation signal PWM according to the control signal CS.

As shown in FIG. 1, the adapter 10 is configured to receive an alternating current signal AC (for example, an 110V or 240V alternating current voltage), convert the received alternating current signal AC to a direct current signal DC (for example, an 19V direct current voltage) and then output the direct current signal DC to the touch device 20. The touch device 20 processes the received 19V direct current voltage and accordingly generates a direct current operating power (e.g., a 3.3V direct current voltage, not shown) to drive the touch control circuit 21. In general, the touch control circuit 21 generates a sensing signal with a specific frequency to sense whether or not the touch device 20 is being touched. Specifically, when the touch device 20 is being touched, the position of the touched point can be determined according to a touch signal, which is generated according to the sensing signal. In the present embodiment, the touch control circuit 21 adjusts its operating frequency (i.e., the frequency of the aforementioned sensing signal) within a preset time period, so as to make the operating frequency and the noise frequency of the operating power (not shown) supplied to the touch control circuit 21 different with each other. In one embodiment, the preset time period is 30 frames, and the present invention is not limited thereto. In one embodiment, the touch control circuit 21 further transmits the control signal CS to the control circuit 13 when the operating frequency is not adjusted to be different with the aforementioned noise frequency within the preset time period. It is to be noted that the noise frequency of the operating power, in certain circumstances, relates to the frequency of the switch on or off of the switch 12. Thus, the noise frequency of the operating power supplied to the touch control circuit 21 is adjustable through configuring the control circuit 13 to adjust at least one of the frequency, duty cycle, rising time or falling time of the pulse width modulation signal PWM according to the control signal CS.

Besides within the preset time period, the touch control circuit 21 in one embodiment may also adjust its operating frequency according to a preset adjustment count. In one embodiment, the preset adjustment count is 20, and the present invention is not limited thereto. Specifically, the touch control circuit 21 also transmits the control signal CS to the control circuit 13 when the operating frequency is not adjusted to be different with the aforementioned noise frequency within the aforementioned adjustment count.

In the present disclosure, the adapter 10 and the touch device 20 may be electrically connected with each other via a universal serial bus (USB), and is not limited thereto. The control signal CS may be transmitted to the control circuit 13 by way of USB, inter integrated circuit (I2C) or serial peripheral interface (SPI).

The conversion mean between the aforementioned alternating current signal AC and the direct current signal DC and the generation mean of the operating power supplied to the touch control circuit 21 are well known to those ordinarily skilled in the art, and no redundant detail is to be given herein. The aforementioned electrical connection mean between the adapter 10 and the touch device 20 and the signal format of the control signal CS transmitted to the control circuit 13 are provided for an exemplary purpose only, and the present disclosure is not limited thereto.

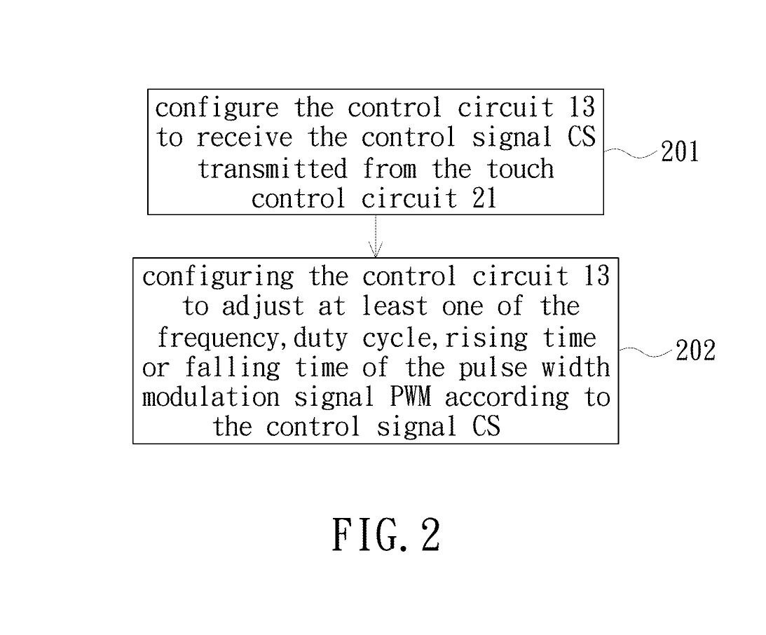

FIG. 2 is a flow char of a noise eliminating method in accordance with an embodiment of the present disclosure. Please refer to FIGS. 1 and 2. The noise eliminating method in the present embodiment includes steps of: configuring the control circuit 13 to receive the control signal CS transmitted from the touch control circuit 21 (step 201); and configuring the control circuit 13 to adjust at least one of the frequency, duty cycle, rising time or falling time of the pulse width modulation signal PWM according to the control signal CS (step 202).

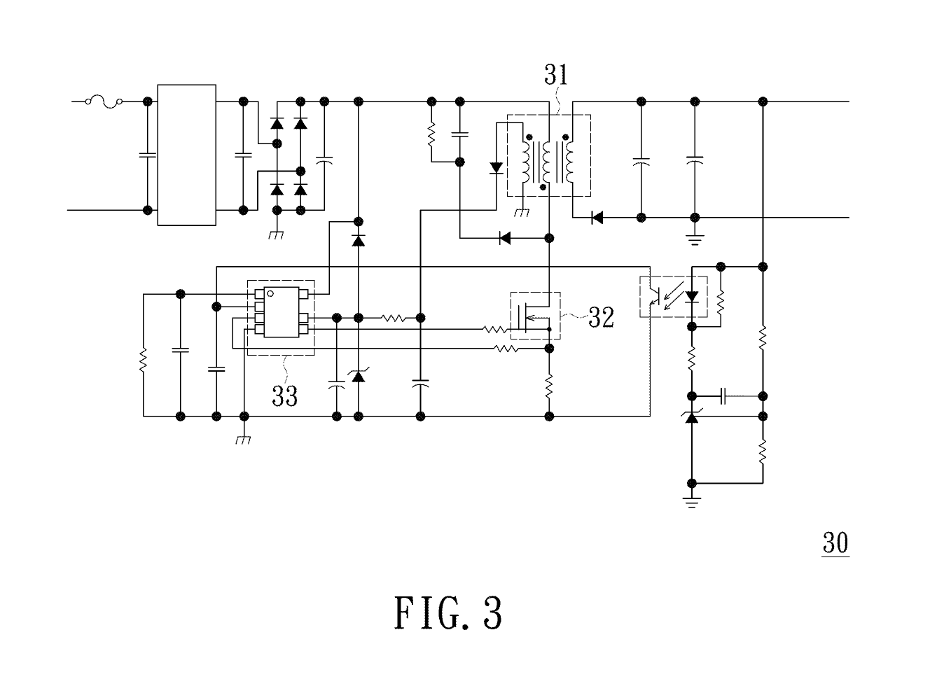

FIG. 3 is a schematic circuit diagram of a flyback-type adapter in accordance with an embodiment of the present disclosure. As shown in FIG. 3, the flyback-type adapter 30 in the present embodiment includes a voltage transformer 31, a switch 32 and a control circuit 33. The remaining unlabeled components/devices in FIG. 3 are not the essential bodies in the present disclosure, and no redundant detail is to be given herein. The voltage transformer 31 in the present embodiment is equivalent to the voltage transformer 11 in FIG. 1; the switch 32 in the present embodiment is equivalent to the switch 12 in FIG. 1; and the control circuit 33 in the present embodiment is equivalent to the control circuit 13 in FIG. 1. It is to be noted that the flyback-type adapter 30 of FIG. 3 is only an exemplary implementation of the adapter 10 in FIG. 1, and the present disclosure is not limited thereto. The noise eliminating process and mean of the flyback-type adapter 30 have been described above, and no redundant detail is to be given herein.

In summary, through configuring a touch control circuit in a touch device to provide a control signal to a control circuit in an adapter and configuring the control circuit in the adapter to adjust at least one of the frequency, duty cycle, rising time or falling time of a pulse width modulation signal according to the control signal, the frequency of the switch on or off of a switch in the adapter is adjustable and consequentially the noise can be eliminated in the present disclosure.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A noise eliminating method adapted to be used with an adapter and a touch device electrically connected with each other, the adapter comprising a voltage transformer, a switch and a control circuit, the voltage transformer comprising a primary side winding and a secondary side winding, the switch being electrically connected between the primary side winding and a reference voltage, the control circuit being configured to output a pulse width modulation signal to switch on or off the switch, the touch device comprising a touch control circuit, the noise eliminating method comprising:
configuring the control circuit to receive a control signal transmitted from the touch control circuit; and
configuring the control circuit to adjust at least one of a frequency, a duty cycle, a rising time or a falling time of the pulse width modulation signal according to the control signal.

2. The noise eliminating method according to claim 1, wherein the touch control circuit is further configured to adjust its operating frequency within a preset time period so as to make the operating frequency and a noise frequency of an operating power supplied to the touch control circuit different with each other, wherein the touch control circuit transmits the control signal to the control circuit of the adapter when the operating frequency is not adjusted to be different with the noise frequency within the preset time period.

3. The noise eliminating method according to claim 2, wherein the preset time period is 30 frames.

4. The noise eliminating method according to claim 1, wherein the touch control circuit is further configured to adjust its operating frequency so as to make the operating frequency and a noise frequency of an operating power supplied to the touch control circuit different with each other, wherein the touch control circuit transmits the control signal to the control circuit of the adapter when the operating frequency is not adjusted to be different with the noise frequency within a preset adjustment count.

5. The noise eliminating method according to claim 4, wherein the preset adjustment count is 20.

6. The noise eliminating method according to claim 1, wherein the control signal is transmitted to the control circuit of the adapter by way of a universal serial bus (USB), an inter integrated circuit (I2C) or a serial peripheral interface (SPI).

7. An adapter, comprising:
a voltage transformer, comprising a primary side winding and a secondary side winding;
a switch, electrically connected between the primary side winding and a reference voltage; and
a control circuit, configured to output a pulse width modulation signal to switch on or off the switch,
wherein the control circuit is further configured to adjust at least one of a frequency, a duty cycle, a rising time or a falling time of the pulse width modulation signal according to a control signal.

8. The adapter according to claim 7, wherein the adapter is electrically connected to a touch device, the touch device comprises a touch control circuit configured to transmit the control signal.

9. The adapter according to claim 8, wherein the touch control circuit is further configured to adjust its operating frequency within a preset time period so as to make the operating frequency and a noise frequency of an operating power supplied to the touch control circuit different with each other, wherein the touch control circuit transmits the control signal to the control circuit of the adapter when the operating frequency is not adjusted to be different with the noise frequency within the preset time period.

10. The adapter according to claim 9, wherein the preset time period is 30 frames.

11. The adapter according to claim 8, wherein the touch control circuit is further configured to adjust its operating frequency so as to make the operating frequency and a noise frequency of an operating power supplied to the touch control circuit different with each other, wherein the touch control circuit transmits the control signal to the control circuit of the adapter when the operating frequency is not adjusted to be different with the noise frequency within a preset adjustment count.

12. The adapter according to claim 11, wherein the preset adjustment count is 20.

13. The adapter according to claim 8, wherein the adapter and the touch device are electrically connected with each other via a universal serial bus (USB).

14. The adapter according to claim 8, wherein the control signal is transmitted to the control circuit of the adapter by way of a universal serial bus (USB), an inter integrated circuit (I2C) or a serial peripheral interface (SPI).
